(19) United States
(12) Patent Application Publication
(10) Pub. No.: US 2014/0152266 A1
(43) Pub. Date: Jun. 5, 2014

(54) BATTERY MANAGEMENT SYSTEM AND MANAGING METHOD THEREOF

(71) Applicant: FAIRCHILD KOREA SEMICONDUCTOR LTD., Bucheon (KR)

(72) Inventors: Eun CHEON, Seoul (KR); Jinhwa CHUNG, Seoul (KR)

(73) Assignee: FAIRCHILD KOREA SEMICONDUCTOR LTD., Bucheon (KR)

(21) Appl. No.: 14/098,025

(22) Filed: Dec. 5, 2013

(30) Foreign Application Priority Data
Dec. 5, 2012 (KR) 10-2012-0140425

(51) Int. Cl. H02J 7/00

(52) U.S. Cl. CPC H02J 7/0014
USPC 320/134

(57) ABSTRACT

A battery management system and a driving method are provided. The battery management system performs a bleeding operation at a moment that a voltage of each cell becomes a reference voltage during an initial charging operation to smoothly change a slope of a charge voltage. Accordingly, the charging time of the cell initially charging at the low voltage is increased, thereby reducing the entire cell balancing period.

### CROSS-REFERENCE TO RELATED APPLICATION

This application claims priority to and the benefit of Korean Patent Application No. 10-2012-0140425 filed in the Korean Intellectual Property Office on Dec. 5, 2012, the entire contents of which are incorporated herein by reference.

### BACKGROUND OF THE INVENTION

(a) Field of the Invention

The present invention relates to a battery management system and a managing method thereof.

(b) Description of the Related Art

A battery has a function of being charged with electrical energy to supply the electrical energy to various electronic devices. Particularly, a secondary battery may be recharged with the electrical energy and is realized as a stack of a plurality of cells to increase output thereof. The secondary battery including the plurality of cells needs a battery management system (hereafter, referred to as “BMS”) managing the plurality of cells.

When multiple cells are coupled in series, balancing of the mutual cells is important factor. The balancing of the mutual cells, that is, the cell balancing, means to maintain each voltage charged to the plurality of cells forming the battery within a permitted range. The cell balancing closely relates to life-span of the battery and output power, and when the cell balancing is not ordinarily operated, the cell is deteriorated such that the life-span of the battery is not only shortened but also the output power may be reduced.

In a conventional balancing method, a separate resistor is respectively disposed for a plurality of cells, and the voltage of each cell is measured to discharge a cell having a high voltage through line resistance thereby decreasing the voltage of the cell. It is assumed that the voltage of a first cell is higher than the voltage of a second cell in a battery including the first cell and the second cell. When simultaneously charging the first cell and the second cell, the first cell is charged until reaching a highest voltage of the permitted range. At this time, the first cell is discharged through the resistor, and the charging of the second cell is stopped. Also, when the first cell is discharged until reaching a predetermined voltage, the first cell and the second cell are again simultaneously charged. When this operation is repeated such that the voltage difference between the first cell and the second cell is in a predetermined range, the balancing is finally finished.

However, in the conventional method, the time that it takes for the first cell to initially reach the highest voltage is short such that the initial charging time of the second cell is short, and thereby the cell balancing period is increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a battery management system having a fast cell balancing period and a managing method thereof.

According to an exemplary embodiment of the present invention, a battery management system is provided. The battery management system includes: a charging switch charging a first cell having a first voltage and a second cell having a second voltage lower than the first voltage into a first current; a plurality of balancing switches respectively coupled to the first cell and the second cell and respectively discharging the first cell and the second cell into a second current; and a controller controlling the charging or the discharging of the first cell and the second cell to position the first voltage of the first cell between a maximum voltage and a first reference voltage lower than the maximum voltage, and turning-on the balancing switch of the first cell till the second voltage becomes a second reference voltage if the first voltage of the first cell reaches the second reference voltage lower than the first reference voltage at a time of the changing

The first current may be higher than the second current

The controller may turn-off the balancing switch of the first cell till the first voltage becomes the maximum voltage if the second voltage reaches the second reference voltage. The controller may maintain the balancing switch of the second cell as a turn-off state if the second voltage reaches the second reference voltage

The controller may turn-off the charging switch, turns-on the balancing switch of the first cell, and turns-off the balancing switch of the second cell till the first voltage becomes the first reference voltage if the first voltage reaches the maximum voltage and the second voltage is lower than the first reference voltage. The controller may turn-on the charging switch and turn-on the balancing switch of the first cell and the balancing switch of the second cell till the first voltage becomes the maximum voltage if the first voltage reaches the first reference voltage and the second voltage is lower than the first reference voltage. The controller may turn-on the charging switch and turn-off the balancing switch of the first cell and the balancing switch of the second cell till the first voltage becomes the maximum voltage if the first voltage reaches the first reference voltage and the second voltage is lower than the first reference voltage.

The battery management system may further include: a selector receiving and transmitting an information of the first voltage, an information of the second voltage, an information of the first current, and an information of the second current to the controller.

The battery management system may further include: a switch driver controlled by the controller and driving the plurality of balancing switch and the charging switch.

According to another exemplary embodiment of the present invention, a battery managing method is provided. The battery managing method includes: charging a first cell having a first voltage and a second cell having a second voltage lower than the first voltage into a first current by using a charging switch; comparing the first voltage and the second voltage with a first reference voltage lower than a maximum voltage; controlling a charging or a discharging of the first cell and the second cell to position the first voltage of the first cell between the maximum voltage and the first reference voltage; and turning-on a first balancing switch corresponding to the first cell till the second voltage becomes a second reference voltage if the first voltage of the first cell reaches the second reference voltage lower than the first reference voltage.

The first current may be higher than the second current

The battery managing method may further include: turning-off the first balancing switch till the first voltage becomes the maximum voltage if the second voltage reaches the second reference voltage. The battery managing method may further include: maintaining a second balancing switch corresponding to the second cell as a turn-off state if the second voltage reaches the second reference voltage.

The battery managing method may further include: turning-off the charging switch, turning-on the first balancing switch, and turning-off a second balancing switch corresponding to the second cell till the first voltage becomes the first reference voltage if the first voltage reaches the maximum voltage and the second voltage is lower than the first reference voltage. The battery managing method may further include: turning-on the charging switch and turning-on the first balancing switch and the second balancing switch till the first voltage becomes the maximum voltage if the first voltage reaches the first reference voltage and the second voltage is lower than the first reference voltage. The battery managing method may further include: turning-on the charging switch and turning-off the first balancing switch and the second balancing switch till the first voltage becomes the maximum voltage if the first voltage reaches the first reference voltage and the second voltage is lower than the first reference voltage.

The battery managing method may further include: receiving an information of the first voltage and an information of the second voltage.

### BRIEF DESCRIPTION OF THE DRAWINGS

FIG. 1 is a view of a battery management system 100 and a surrounding device of the battery management system 100 according to an exemplary embodiment of the present invention.

FIG. 2 is a view of a battery management system 100′ according to another exemplary embodiment of the present invention.

FIG. 3 is a view of a method of performing cell balancing of a battery management system according to an exemplary embodiment of the present invention of a case (Ic≦Ib) that a charging current (Ic) is equal to or less than a bleeding current (Ib).

FIG. 4 is a view of a method of performing cell balancing of a battery management system according to an exemplary embodiment of the present invention of a case (Ic>Ib) that a charging current (Ic) is larger than a bleeding current (Ib).

FIG. 5 is a view of a method of performing cell balancing of a battery management system according to an exemplary embodiment of the present invention of a case (Ic>Ib) that a charging current (Ic) is larger than a bleeding current (Ib).

FIG. 6 is a view comparing a conventional cell balancing method with a cell balancing method according to FIG. 5.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Now, a battery management system and a managing method according to an exemplary embodiment of the present invention will be described with reference to accompanying drawings.

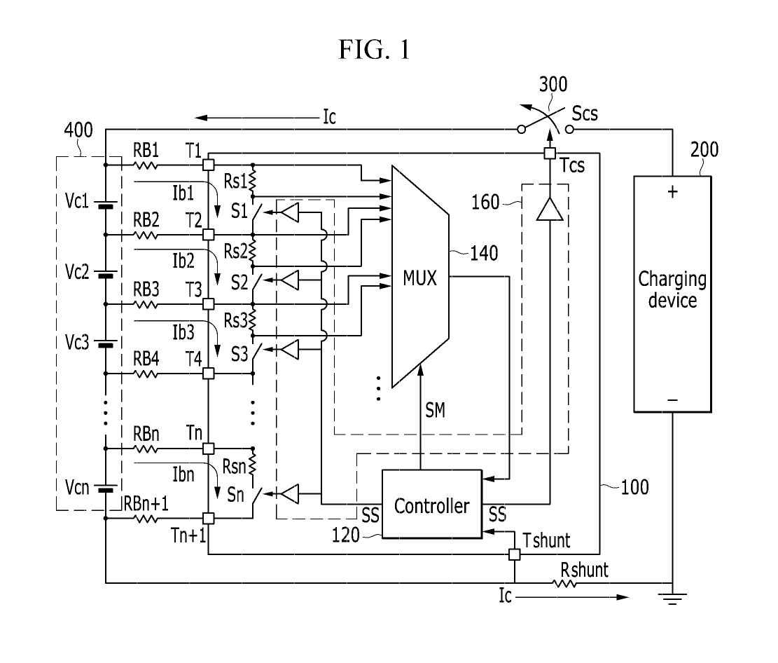

FIG. 1 is a view of a battery management system 100 and a surrounding device of the battery management system 100 according to an exemplary embodiment of the present invention. A surrounding device of the battery management system 100 includes a charging device 200, a charging switch 300 (Scs), a plurality of cells 400, a plurality of bleeding resistors RB1-RBn+1, and a shunt resistor Rshunt, and is connected to the battery management system 100.

The plurality of cells 400 are coupled in series, and each cell is charged with a predetermined voltage. The plurality of cells 400 that are charged with the predetermined voltage that are indicated by Vc1, Vc2, Vc3, . . . Vcn in FIG. 1.

The charging device 200 supplies power to charge the plurality of cells 400, and the charging switch 300 (Scs) is connected between the plurality of cells 400 and the charging device 200 for switching therebetween.

The plurality of bleeding resistors RB1-RBn+1 are respectively connected between the plurality of cells 400 and a plurality of input terminals T1-Tn+1 of the battery management system 100. That is, the bleeding resistor RB1 is connected between one terminal of the first cell Vc1 and the input terminal T1, and the bleeding resistor RB2 is connected between a node of the first cell Vc1 and the second cell Vc2 and the input terminal T2. Also, the bleeding resistor RB3 is connected between a node of the second cell Vc2 and the third cell Vc3 and the input terminal T3, and the bleeding resistor RB4 is connected between a node of the third cell Vc3 and the fourth cell Vc4 and the input terminal T4. The battery management system 100 receives voltage information of the plurality of cells Vc1-Vcn through the input terminals T1-Tn+1. That is, a difference between the voltage of the input terminal T1 and the voltage of the input terminal T2 corresponds to the voltage of the first cell Vc1, and a difference between the voltage of the input terminal T2 and the voltage of the input terminal T3 corresponds to the voltage of the second cell Vc2. In FIG. 1, the plurality of bleeding resistors RB1-RBn+1 are not included inside the battery management system 100, however the battery management system 100 may include the plurality of bleeding resistors RB1-RBn+1.

Meanwhile, the plurality of bleeding resistors RB1-RBn+1 have the same resistance value, however the present invention is not limited thereto. In an exemplary embodiment of the present invention, for convenience of description, the plurality of bleeding resistors Rb1-RBn+1 have the same resistance value.

The shunt resistor Rshunt is connected to an N-th cell Vcn and a ground, and the battery management system 100 may obtain a value of a charging current (Ic) through the voltage of the shunt terminal Tshunt.

A plurality of bleeding currents (Ib1-Ibn) represents currents when a discharging operation is performed to decrease the voltage of the plurality of cells Vc1-Vcn, and the charging current (Ic) represents a current flowing when the plurality of cells Vc1-Vcn are charged by the turn-on of the charging switch Scs. The bleeding currents (Ib1-Ibn) may have the same value or different values.

The battery management system 100 receives the voltage information of the plurality of cells Vc1-Vcn through the input terminals T1-Tn+1 for the cell balancing operation, and receives the information of the charging current (Ic) through the shunt terminal Tshunt. Also, the battery management system 100 turns-on/turns-off the charging switch 300 through the charging switch terminal Tcs.

As shown in FIG. 1, the battery management system 100 according to an exemplary embodiment of the present invention includes a controller 120, a selection unit (MUX) 140, a switch driver 160, a plurality of balancing switches S1-Sn, and a plurality of sensing resistors Rs1-Rsn.

The plurality of balancing switches S1-Sn are connected between the plurality of input terminals T1-Tn+1 for switching the charging and discharging of each cell. That is, when the first balancing switch S1 is turned on, the first cell Vc1 starts the discharging such that the voltage of the first cell Vc1 is reduced, and when the second balancing switch S2 is turned on, the second cell Vc2 starts the discharging such that the voltage of the second cell Vc2 is reduced.

The switch driver 160 includes a switch driver and turns-on/turns-off the plurality of balancing switches S1-Sn and the charging switch 300 according to a control signal SS of the controller 120.

The plurality of sensing resistors Rs1-Rsn are respectively connected between the plurality of input terminals T1-Tn+1 and the plurality of balancing switches S1-Sn. The plurality of sensing resistors Rs1-Rsn are used for measuring the bleeding currents Ib1-Ibn, and each voltage of both terminals of the plurality of sensing resistors Rs1-Rsn is input to the selection unit 140. The selection unit 140 may calculate the bleeding currents Ib1-Ibn through the voltage of both terminals of each sensing resistor.

The selection unit 140 is input with the voltage information of each of the cells Vc1-Vcn through the plurality of input terminals T1-Tn+1, and is input with the information of the bleeding currents Ib1-Ibn through the plurality of sensing resistors Rs1-Rsn. The selection unit 140 converts the input analog information into a digital signal and transmits the information selected according to the control signal SM of the controller 120 to the controller 120. The selection unit 140 may be realized through a level shifter and a sample and hold circuit.

Also, the controller 120 transmits the control signal SM to the selection unit 140, and receives the information to be selected from the selection unit 140 and transmits the control signal SS to drive each switch to the switch driver 160. Also, the controller 120 receives the information of the charging current (Ic) through the shunt terminal Tshunt. The controller 120 may be realized through a microcontroller, and the microcontroller may only process the digital signal. Accordingly, although not shown in FIG. 1, an analog digital converter (ADC) may be positioned between the controller 120 and the shunt terminal Tshunt.

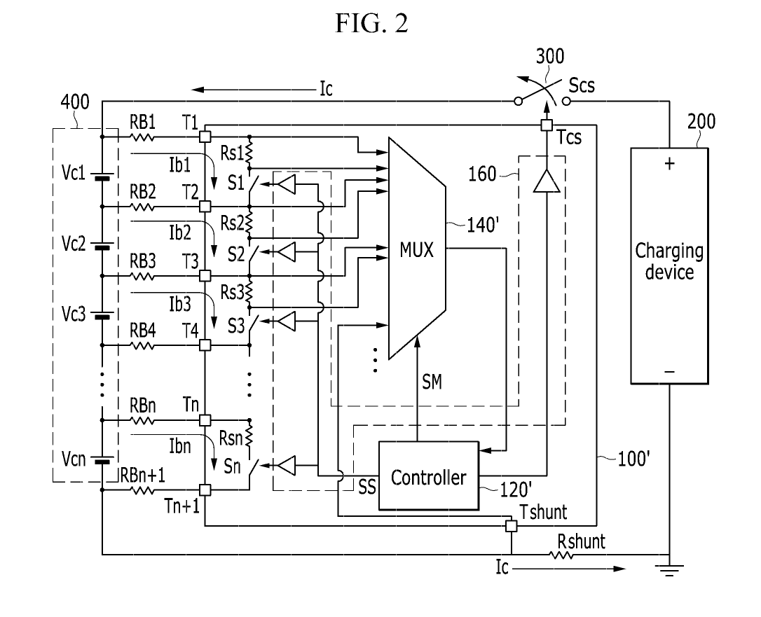

FIG. 2 is a view of a battery management system 100′ according to another exemplary embodiment of the present invention. As shown in FIG. 2, the battery management system 100′ according to another exemplary embodiment of the present invention is the same as that of FIG. 1, except that the voltage of the shunt terminal Tshunt is not input to the controller 120′, but to the selection unit 140′. The selection unit 140′ includes an internal analog digital converter (ADC) such that it is not necessary to include the separate analog digital converter (ADC) like in FIG. 1. In this case, the voltage information of the shunt terminal Tshunt is converted into the digital signal in the selection unit 140′ and transmits it to the controller 120′.

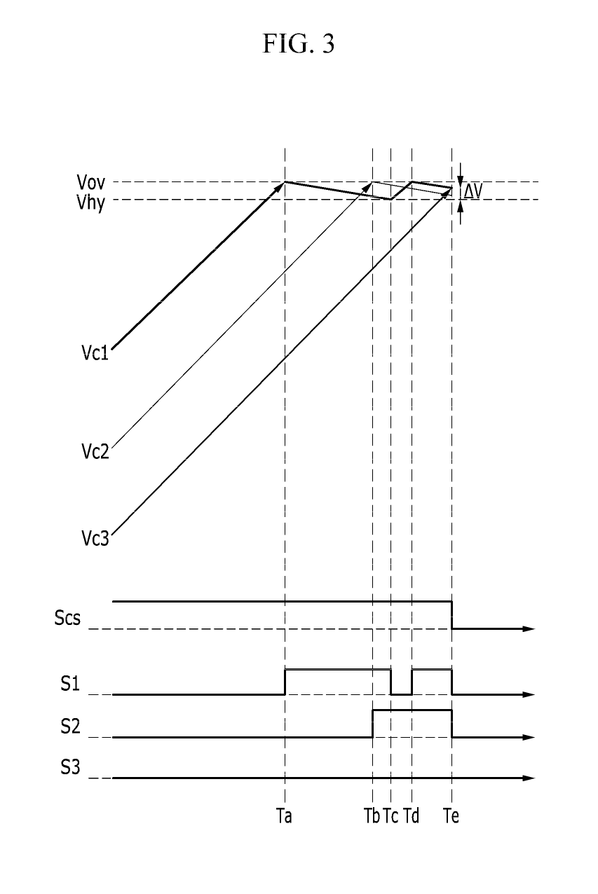

Next, a driving method of a battery management system 100 or 100′ according to an exemplary embodiment of the present invention will be described with reference to FIG. 3 to FIG. 5. That is, a battery management system 100 or 100′ according to an exemplary embodiment of the present invention performs the cell balancing operation, and will be described in detail.

For convenience of description, the cell is provided as three cells Vc1, Vc2, and Vc3, and the voltage size of each cell before the charge of the cell is assumed to be a sequence of the voltage of the first cell, the voltage of the second cell, and the voltage of the third cell (Vc1>Vc2>Vc3). Also, it is assumed that a plurality of bleeding currents (Ib1-Ibn) are the same current (Ib).

A managing method of a battery management system according to an exemplary embodiment of the present invention is different according to the size of the charging current (Ic) and the bleeding current (Ib).

First, a case (Ic≦Ib) that the charging current (Ic) is equal to or less than the bleeding current (Ib) is described.

FIG. 3 is a view of a method of performing cell balancing of a battery management system according to an exemplary embodiment of the present invention of a case (Ic≦Ib) that a charging current (Ic) is equal to or less than a bleeding current (Ib).

In FIG. 3, Vov means a maximum voltage that is permitted when the cell is charged to a maximum, and Vhy means a voltage of a hysteresis operation for the cell balancing and is lower than the maximum voltage Vov.

Firstly, the charging switch Scs is turned on and the first to third balancing switches S1, S2, and S3 are all turned off, so the first cell Vc1, the second cell Vc2, the third cell Vc3 all undergo the charging operation. At this time, the first cell Vc1, the second cell Vc2, and the third cell Vc3 charging voltages have the same slope.

At a time that the voltage of the first cell Vc1 becomes the maximum voltage Vov (i.e., in FIG. 3, a time Ta), the first balancing switch S1 turned on. At this time, the charging switch Scs maintains the turn-on state, and the second balancing switch S2 and the third balancing switch S3 maintain the turn-off state. By the turn-on of the first balancing switch S1, the bleeding current Ib1 flows through the bleeding resistor RB1, the sensing resistor Rs1, the first balancing switch S1, and the bleeding resistor Rb2, and thereby the voltage of the first cell Vc1 is discharged and is thus decreased. Here, when the charging current (Ic) is smaller than the bleeding current (Ib), as shown in FIG. 3, the voltage of the first cell Vc1 is decreased, while when the charging current (Ib) is the same as the bleeding current (Ib), differently from FIG. 3, the voltage of the first cell Vc1 is not decreased and is maintained as it is. Meanwhile, the charging switch Scs still maintains the turn-on state such that the second cell Vc2 and the third cell Vc2 are still charged and thereby their voltages are increased.

At the moment that the voltage of the second cell Vc2 becomes the maximum voltage Vov (in FIG. 3, the time Tb), the second balancing switch S2 is turned on. By the turn-on of the second balancing switch S2, the bleeding current Ib2 flows through the bleeding resistor RB2, the sensing resistor Rs2, the second balancing switch S2, and the bleeding resistor RB3, and thereby the voltage of the second cell Vc2 is decreased. Here, since the voltage of the first cell Vc1 is not the hysteresis voltage Vhy, the first balancing switch S1 maintains the turn-on state and the voltage of the first cell Vc1 is continuously decreased. Also, the charging switch Scs maintains the turn-on state and the third balancing switch S3 maintains the turn-off state such that the voltage of the third cell Vc3 is increased.

Next, at the moment that the voltage of the first cell Vc1 becomes the hysteresis voltage Vhy (in FIG. 3, a time Tc), the first balancing switch S1 is turned off. At this time, since the charging switch Scs maintains the turn-on state, the first cell Vc1 performs the charging operation such that the voltage of the first cell Vc1 is increased. Also, the voltage of the second cell Vc2 is still not the hysteresis voltage Vhy such that the second balancing switch S2 maintains the turn-on state and the voltage of the second cell Vc2 is continuously decreased. Also, the voltage of the third cell Vc3 is still not the maximum voltage Vov such that the third balancing switch S3 maintains the turn-off state, and the voltage of the third cell Vc3 is continuously increased through the charging operation.

At the moment that the voltage of the first cell Vc1 is increased to be the maximum voltage Vov (in FIG. 3, a time Td), the first balancing switch S1 is turned on. Thus, the bleeding current Ib1 flows such that the first cell Vc1 is discharged, and thereby the voltage of the first cell Vc1 is decreased. Meanwhile, the voltage of the second cell Vc2 is still not the hysteresis voltage Vhy such that the second balancing switch S2 maintains the turn-on state and the voltage of the second cell Vc1 is decreased. Also, the voltage of the third cell Vc3 is still not the maximum voltage Vov such that the third balancing switch S3 maintains the turn-off state and the voltage of the third cell Vc3 is increased through the charging operation.

By a repetition of these operations, at a time when a difference between voltages of the first to third cells Vc1, Vc2, and Vc3 is decreased within a predetermined voltage (ΔV) (in FIG. 3, a time Te), the charging switch Scs is turned off, and the cell balancing operation is completed.

According to an exemplary embodiment of the present invention, in each cell, the balancing switch is turned on at the moment that the cell voltage becomes the maximum voltage Vov and the balancing switch is turned off at the moment that the cell voltage becomes the hysteresis voltage Vov. Also, the charging switch Scs continuously maintains the turn-on state until the voltage difference between the cells is decreased within the predetermined voltage (ΔV). As described above, while the balancing switch is turned on such that the bleeding operation is performed, the charging switch Scs continuously maintains the turn-on state such that the cell (in FIG. 3, Vc3) having the low voltage also undergoes the charging operation, and thereby the cell balancing is completed within a short time.

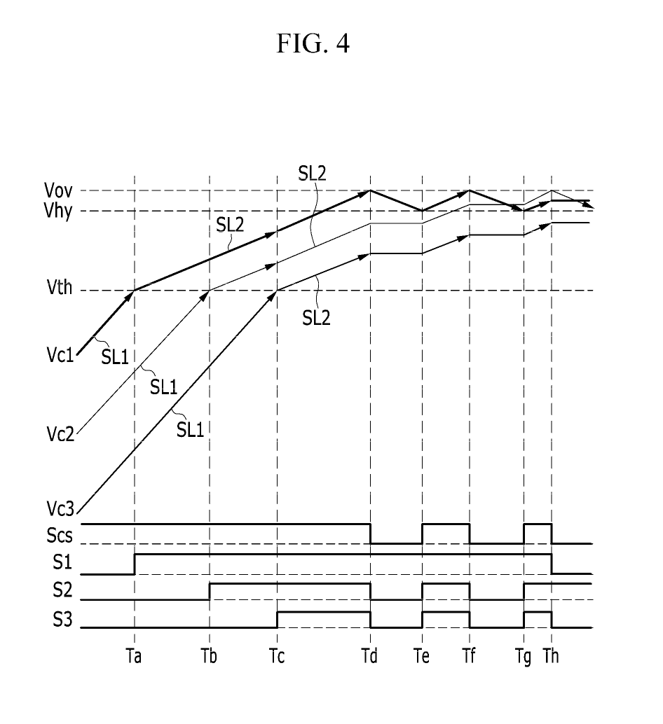

Next, referring to FIG. 4, a case (Ic>Ib) that the charging current (Ic) is larger than the bleeding current (Ib) will be described.

FIG. 4 is a view of a method of performing cell balancing of a battery management system according to an exemplary embodiment of the present invention of a case (Ic>Ib) that a charging current (Ic) is larger than a bleeding current (Ib).

In FIG. 4, as a reference voltage Vth of a voltage that is lower than the maximum voltage Vov and the hysteresis voltage Vhy, at the moment that the voltage of each cell becomes the reference voltage Vth, the balancing switch is turned on such that the bleeding operation is performed.

The charging switch Scs is turned on until the time (in FIG. 4, the times Ta, Tb, and Tc) when the voltage of each cell becomes the reference voltage Vth, and accordingly, the cells Vc1, Vc2, and Vc3 are charged with the amount of the charge current (Ic) such that the voltage is increased. The voltage of the cell is increased by the first slope SL1 by corresponding to the amount of the charge current (Ic).

At the time (in FIG. 4, the times Ta, Tb, and Tc) that the voltage of each cell becomes the reference voltage Vth, the balancing switch of each cell is turned on. That is, the first balancing switch S1 is turned on at the time Ta, the second balancing switch S2 is turned on at the time Tb, and the third balancing switch S3 is turned on at the time Tc. At this time, the charging switch Scs maintains the turn-on state. At this times Ta, Tb, and Tc that the balancing switches S1, S2, and S3 of each cell are turned on, the bleeding currents Ib1, Ib2, and Ib3 flow to each cell, and the charging current (Ic) is larger than the bleeding current (Ib) such that the voltage of each of the cells Vc1, Vc2, and Vc3 is increased by the amount corresponding to the current Ic-Ib. Here, the voltage of each of the cells Vc1, Vc2, and Vc3 has the second slope SL2 that is smaller than the first slope and is increased.

At the time (in FIG. 4, the time Td) when the voltage of the first cell Vc1 becomes the maximum voltage Vov, the charging switch Scs is turned off and the first balancing switch S1 maintains the turn-on state. Accordingly, the charging current (Ic) does not flow to the first cell Vc1 and only the bleeding current Ib1 flows such that the voltage of the first cell Vc1 is decreased. Also, the second balancing switch S2 and the third balancing switch S3 are turned off such that the voltages of the second cell Vc2 and the third cell Vc3 are not increased.

At the time (in FIG. 4, the time Te) when the voltage of the first cell Vc1 is decreased to be the hysteresis voltage Vhy, the first balancing switch to the third balancing switch S1-S3 are turned on. Also, the charging switch Scs is turned on. Thus, the voltages of the first cell to the third cell Vc1-Vc3 are increased with the second slope SL2.

At the time (the time Tf in FIG. 4) when the voltage of the first cell Vc1 is increased and then again becomes the maximum voltage Vov, the charging switch Scs is turned off and the first balancing switch S1 maintains the turn-on state. Also, the second balancing switch S2 and the third balancing switch S3 are turned off. Thus, the bleeding current Ib1 only flows to the first cell Vc1 such that the voltage of the first cell Vc1 is decreased, and the voltages of the second cell Vc2 and the third cell Vc3 are maintained.

At the time (the time Tg in FIG. 4) when the voltage of the first cell Vc1 is decreased and becomes the hysteresis voltage Vhy, the first to third balancing switches S1-S3 and the charging switch Scs are turned on. Thus, the voltages of the first to third cells Vc1-Vc3 are increased with the second slope SL2.

Further, at the time (the time Th in FIG. 4) when the voltage of the second cell Vc2 is increased and then becomes the maximum voltage Vov, the charging switch Scs is turned off and the first balancing switch S1 is turned off. In addition, the second balancing switch S2 maintains the turn-on state and the third balancing switch S3 is turned off. Thus, the bleeding current Ib2 only flows to the second cell Vc2 such that the voltage of the second cell Vc2 is decreased, and the voltages of the first cell Vc1 and the third cell Vc3 are maintained.

By the repetition of the above operation, at the time when the difference between the voltages of the first to the third cells Vc1, Vc2, and Vc3 is decreased within the predetermined voltage (ΔV), the cell balancing operation is finished.

According to an exemplary embodiment of the present invention, at the time when the voltage of each cell becomes the reference voltage Vth, each balancing switch is turned on such that the charging current and the bleeding current flow, and thereby the voltage of each cell is increased to the second slope SL2 that is lower than the first slope SL1. The cell initially charged with the high voltage further slowly becomes the maximum voltage Vov and the cell initially charged with the low voltage performs the charging operation during a further long time such that the voltage difference for the cell charged with the high voltage may be further reduced. Accordingly, the cell balancing operation is completed quickly.

Meanwhile, as shown in FIG. 4, in the case (Ic>Ib) that the charging current (Ic) is larger than the bleeding current (Ib), a method of more quickly completing the cell balancing will be described.

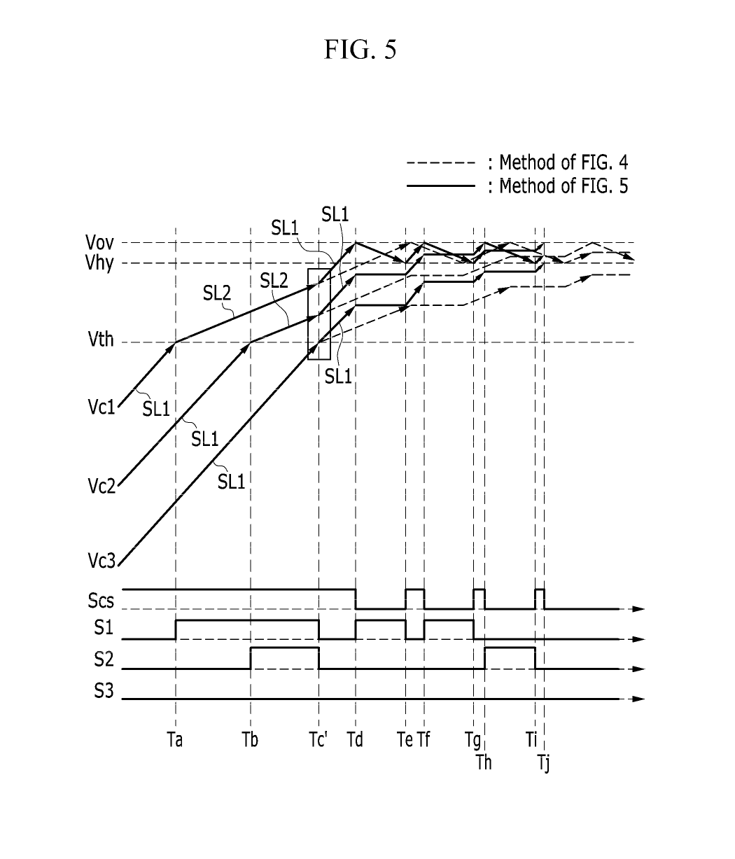

FIG. 5 is a view of a method of performing cell balancing of a battery management system according to an exemplary embodiment of the present invention of a case (Ic>Ib) that a charging current (Ic) is larger than a bleeding current (Ib).

As shown in FIG. 5, the cell balancing method of FIG. 5 is the same as the cell balancing shown in FIG. 4 except for the following difference. As shown in FIG. 5, at the time Tc′ when the voltage of all cells Vc1-Vc3 becomes the reference voltage Vth, all balancing switches S1-S3 are turned off and the charging switch Scs continuously maintains the turn-on state. Thus, at the time Tc′, the charging current (Ic) only flows to the first to third cells Vc1-Vc3 such that the voltage of the first to third cells Vc1-Vc3 is increased with the first slope SL1. That is, at the time Ta, the first balancing switch S1 is turned on such that the voltage of the first cell Vc1 is increased to the second slope SL2 that is lower than the first slope SL1, at the time Tb, the second balancing switch S2 is turned on such that the voltage of the second cell Vc2 is increased to the second slope SL2, and at the time Tc′, the voltage of all cells Vc1-Vc3 is higher than the reference voltage Vth such that all balancing switches S1-S3 are turned off, and thereby the voltage of all cells Vc1-Vc3 is increased to the first slope SL1. The following operations are the same as those of FIG. 4 and the detailed description is omitted.

In the cell balancing method of FIG. 5 different from FIG. 4, at the moment that the voltage of all cells Vc1-Vc3 becomes the reference voltage Vth, the voltage is increased with the first slope SL1 such that the cell balancing may be completed at a faster time than in FIG. 4. A dotted line in FIG. 5 indicates the cell balancing method of FIG. 4.

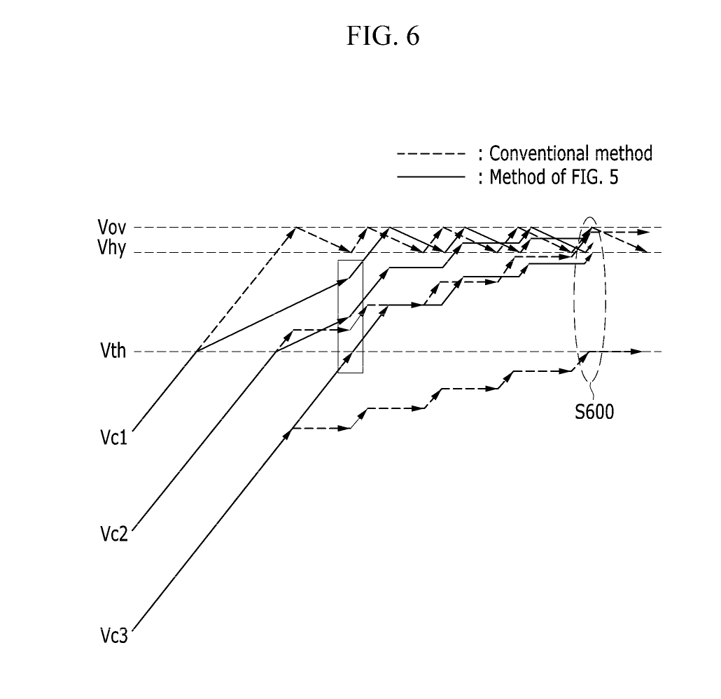

FIG. 6 is a view comparing a conventional cell balancing method with a cell balancing method according to FIG. 5.

In FIG. 6, the solid line indicates performing the cell balancing according to the method of FIG. 5, and the dotted line indicates performing the cell balancing according to a conventional method.

In the conventional method, during the charging operation, without a change of an increasing slope of the voltage of each cell, the bleeding operation when the voltage of the cell becomes the maximum voltage Vov and the additional charging operation when the voltage of the cell becomes the hysteresis voltage Vhy are repeated. In this conventional method, the cell initially charged with the high voltage becomes the maximum voltage Vov quickly such that the charging operation is short. However, in an exemplary embodiment of the present invention, the cell initially charged with the high voltage becomes the maximum voltage Vov slowly such that the time of the charging operation is long, and accordingly, the voltage difference of each cell may be further quickly reduced. That is, as indicated by S600 of FIG. 6, in the cell balancing method according to an exemplary embodiment of the present invention, the voltage difference of each cell is further quickly reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A battery management system comprising:
a charging switch charging a first cell having a first voltage and a second cell having a second voltage lower than the first voltage into a first current;
a plurality of balancing switches respectively coupled to the first cell and the second cell and respectively discharging the first cell and the second cell into a second current; and
a controller controlling the charging or the discharging of the first cell and the second cell to position the first voltage of the first cell between a maximum voltage and a first reference voltage lower than the maximum voltage, and turning-on the balancing switch of the first cell till the second voltage becomes a second reference voltage if the first voltage of the first cell reaches the second reference voltage lower than the first reference voltage at a time of the changing.

2. The battery management system of claim 1, wherein:
the first current is higher than the second current.

3. The battery management system of claim 1, wherein:
the controller turns-off the balancing switch of the first cell till the first voltage becomes the maximum voltage if the second voltage reaches the second reference voltage.

4. The battery management system of claim 3, wherein:
the controller maintains the balancing switch of the second cell as a turn-off state if the second voltage reaches the second reference voltage.

5. The battery management system of claim 1, wherein:
the controller turns-off the charging switch, turns-on the balancing switch of the first cell, and turns-off the balancing switch of the second cell till the first voltage becomes the first reference voltage if the first voltage reaches the maximum voltage and the second voltage is lower than the first reference voltage.

6. The battery management system of claim 5, wherein:
the controller turns-on the charging switch and turns-on the balancing switch of the first cell and the balancing switch of the second cell till the first voltage becomes the maximum voltage if the first voltage reaches the first reference voltage and the second voltage is lower than the first reference voltage.

7. The battery management system of claim 5, wherein:
the controller turns-on the charging switch and turns-off the balancing switch of the first cell and the balancing switch of the second cell till the first voltage becomes the maximum voltage if the first voltage reaches the first reference voltage and the second voltage is lower than the first reference voltage.

8. The battery management system of claim 1, further comprising:
a selector receiving and transmitting an information of the first voltage, an information of the second voltage, an information of the first current, and an information of the second current to the controller.

9. The battery management system of claim 1, further comprising:
a switch driver controlled by the controller and driving the plurality of balancing switch and the charging switch.

10. A battery managing method comprising:
charging a first cell having a first voltage and a second cell having a second voltage lower than the first voltage into a first current by using a charging switch;
comparing the first voltage and the second voltage with a first reference voltage lower than a maximum voltage;
controlling a charging or a discharging of the first cell and the second cell to position the first voltage of the first cell between the maximum voltage and the first reference voltage; and
turning-on a first balancing switch corresponding to the first voltage of the first cell till the second voltage becomes a second reference voltage if the first cell reaches the second reference voltage lower than the first reference voltage.

11. The battery managing method of claim 10, wherein:
the first current is higher than the second current.

12. The battery managing method of claim 10, further comprising:
turning-off the first balancing switch till the first voltage becomes the maximum voltage if the second voltage reaches the second reference voltage.

13. The battery managing method of claim 12, further comprising:
maintaining a second balancing switch corresponding to the second cell as a turn-off state if the second voltage reaches the second reference voltage.

14. The battery managing method of claim 10, further comprising:
turning-off the charging switch, turning-on the first balancing switch, and turning-off a second balancing switch corresponding to the second cell till the first voltage becomes the first reference voltage if the first voltage reaches the maximum voltage and the second voltage is lower than the first reference voltage.

15. The battery managing method of claim 14, further comprising:
turning-on the charging switch and turning-on the first balancing switch and the second balancing switch till the first voltage becomes the maximum voltage if the first voltage reaches the first reference voltage and the second voltage is lower than the first reference voltage.

16. The battery managing method of claim 14, further comprising:
turning-on the charging switch and turning-off the first balancing switch and the second balancing switch till the first voltage becomes the maximum voltage if the first voltage reaches the first reference voltage and the second voltage is lower than the first reference voltage.

17. The battery managing method of claim 10, further comprising: receiving an information of the first voltage and an information of the second voltage.
